(19) United States
(12) Patent Application Publication
(10) Pub. No.: US 2014/0311241 A1
(43) Pub. Date: Oct. 23, 2014

(54) MEMS PRESSURE SENSOR, ELECTRONIC DEVICE, ALTIMETER, ELECTRONIC APPARATUS, AND MOVING OBJECT

(71) Applicant: Seiko Epson Corporation, Tokyo (JP)

(72) Inventor: Yoji KITANO, Chino (JP)

(73) Assignee: Seiko Epson Corporation, Tokyo (JP)

(21) Appl. No.: 14/257,328

(22) Filed: Apr. 21, 2014

(30) Foreign Application Priority Data
Apr. 22, 2013 (JP) 2013-089119

(51) Int. Cl. G01L 9/00

(52) U.S. Cl. CPC G01L 9/0016
USPC 73/384; 73/702

(57) ABSTRACT

A MEMS pressure sensor includes a diaphragm portion that becomes displaced according to a pressure, and a resonator arranged on a main surface of the diaphragm portion. The resonator includes: a first fixed electrode provided on the main surface; and a drive electrode having a second fixed electrode provided on the main surface, a movable electrode spaced apart from the first fixed electrode, overlapping with the first fixed electrode, as viewed in a plan view seen from a normal direction to the main surface, and driven in a direction that intersects the main surface, and a supporting electrode supporting the movable electrode and connected to the second fixed electrode.

### TECHNICAL FIELD

The present invention relates to a MEMS pressure sensor, an electronic device, an altimeter, an electronic apparatus, and a moving object.

### BACKGROUND ART

Traditionally, as a device for detecting a pressure, a semiconductor pressure sensor as disclosed in JP-A-2001-332746 is known. In the semiconductor pressure sensor disclosed in JP-A-2001-332746, a strain sensing element is formed on a silicon wafer, the surface of the silicon wafer that is opposite to the surface where the strain sensing element is formed is ground to reduce the thickness and thus form a diaphragm portion, a strain generated in the diaphragm portion displaced by a pressure is detected by the strain sensing element, and the result of the detection is converted into electrical signal.

### Technical Problem

However, in the pressure sensor having the strain sensing element disclosed in JP-A-2001-332746, the silicon wafer needs to be thin, making it difficult to integrate the pressure sensor with a semiconductor device (IC) serving as an arithmetic unit that processes a signal from the pressure sensor.

Meanwhile, a so-called MEMS (micro electro mechanical systems) element, that is, a micro mechanical system manufactured by a semiconductor device manufacturing method and device, is attracting attention. The use of a MEMS element enables provision of various types of very small sensors or oscillators or the like. In these sensors or oscillators, a micro oscillating element can be formed on a substrate by the MEMS technique, and an element that carries out detection of acceleration, generation of a reference signal and the like, using the oscillation characteristic of the oscillating element, can be provided.

By forming an oscillating element using this MEMS technique, and forming a pressure sensor that detects pressure based on a change in the oscillation frequency of the MEMS oscillating element, it is possible to realize a pressure sensor integrated with an IC. Moreover, a thin diaphragm portion can be formed in a substrate and can be deformed even by a low pressure. Thus, a MEMS pressure sensor that can form a pressure sensor capable of accurately measuring a very small pressure is provided.

### SUMMARY OF THE INVENTION

The invention is made to solve at least a part of the foregoing problems and can be realized in the following forms or application examples.

### Application Example 1

A MEMS pressure sensor according to this application example includes a diaphragm portion that becomes displaced according to a pressure, and a resonator arranged on a main surface of the diaphragm portion. The resonator includes: a first fixed electrode provided on the main surface; and a drive electrode having a second fixed electrode provided on the main surface, a movable electrode spaced apart from the first fixed electrode, overlapping with the first fixed electrode, as viewed in a plan view seen from a normal direction to the main surface, and driven in a direction that intersects the main surface, and a supporting electrode supporting the movable electrode and connected to the second fixed electrode.

According to the MEMS pressure sensor of this application example, as an external pressure is applied to the diaphragm portion, the diaphragm portion flexes, causing a change in the oscillation characteristic of the resonator, that is, in resonance frequency. By deriving the relation between this external pressure and the change in the frequency characteristic of the resonator, a MEMS pressure sensor that detects the external pressure from the change in the frequency characteristic of the resonator can be provided.

### Application Example 2

In the above application example, the diaphragm portion has a recessed portion arranged on a back side of the main surface, and a thin portion made up of a bottom surface of the recessed portion and the main surface. If a distance between opposite ends of the first fixed electrode and the second fixed electrode is a, and a diameter of an inscribed circle in a planar shape as viewed in a plan view seen from a normal direction to the main surface, of the recessed portion of the diaphragm portion, is b_{B},

0<a≦0.3b_{B}

holds.

According to the above application example, a MEMS pressure sensor that has the resonator capable of efficiently converting a deformation of the diaphragm portion due to a pressure applied thereto into a change in the gap between the first fixed electrode and the movable electrode without lowering a signal intensity and thus securely detecting a change in the resonance frequency due to a change in the gap, can be provided.

### Application Example 3

In the above application example, the first fixed electrode is arranged in an area that is concentric with the inscribed circle, having a diameter c in a planar shape as viewed in a plan view seen from a normal direction to the main surface, of the recessed portion of the diaphragm portion. The diameter c is

0<c≦0.93b_{B}.

According to this application example, a MEMS pressure sensor that can generate a large gap between the first fixed electrode and the movable electrode even if the pressure applied to the diaphragm portion is small and the amount of displacement, that is, the amount of flexure of the diaphragm portion is small, and thus can detect a very small pressure, can be provided.

### Application Example 4

In the above application example, if a diameter of a bottom-surface inscribed circle in a planar shape in the bottom surface of the recessed portion is b_{B}, and a diameter of an opening inscribed circle in a planar shape in an opening of the recessed portion is b_{W}, as viewed in a plan view seen from a normal direction to the main surface,

b_{B}<b_{W}

holds.

According to the above application example, a corner portion formed by the bottom surface of the recessed portion and the sidewall of the recessed portion does not have an acute angle. Even if the flexing deformation of the diaphragm portion is repeated, damage to the wafer forming the substrate due to stress concentration in the corner portion can be restrained. Moreover, etching performance in shaping the recessed portion can be improved and productivity can be improved.

### Application Example 5

An electronic device according to this application example includes the MEMS pressure sensor described in the above application example, and a holding unit that holds the opening and the bottom surface of the recessed portion on the back side of the substrate, in a state of being exposed to a pressure changing area.

According to the electronic device of this application example, as an external pressure is applied to the diaphragm portion, the diaphragm portion flexes, causing a change in the oscillation characteristic of the resonator, that is, in resonance frequency. By deriving the relation between this external pressure and the change in the frequency characteristic of the resonator, a pressure sensor as an electronic device that detects the external pressure from the change in the frequency characteristic of the resonator can be provided.

### Application Example 6

An altimeter according to this application example includes the MEMS pressure sensor described in the above application example, a holding unit that holds the opening and the bottom surface of the recessed portion on the back side, in a state of being exposed to a pressure changing area, and a data processing unit that processes measurement data from the MEMS pressure sensor.

According to the altimeter of this application example, as an external pressure is applied to the diaphragm portion, the diaphragm portion flexes, causing a change in the oscillation characteristic of the resonator, that is, in resonance frequency. By deriving the relation between this external pressure and the change in the frequency characteristic of the resonator, an altimeter that detects the external pressure from the change in the frequency characteristic of the resonator and then calculates the altitude based on the pressure value can be provided.

### Application Example 7

An electronic apparatus according to this application example includes the MEMS pressure sensor, the electronic device or the altimeter described in the above application example.

According to the electronic apparatus of this application example, an electronic apparatus that obtains the pressure value of an extremely low pressure and operates based on the pressure value can be provided.

### Application Example 8

A moving object according to this application example includes the MEMS pressure sensor, the electronic device, the altimeter or the electronic apparatus described in the above application example.

According to the moving object of this application example, a moving object that obtains the pressure value of an extremely low pressure and operates based on the pressure value can be provided.

### BRIEF DESCRIPTION OF THE DRAWINGS

FIG. 1 shows a MEMS pressure sensor according to a first embodiment. FIG. 1(a) is a plan view. FIG. 1(b) is a cross-sectional view taken along A-A′ shown in FIG. 1(a). FIG. 1(c) is a cross-sectional view taken along B-B′ shown in FIG. 1(a).

FIG. 2 shows the MEMS pressure sensor according to the first embodiment. FIG. 2(a) shows the configuration of a MEMS oscillator portion for explaining operation in a static state. FIG. 2(b) is a view of the configuration of the MEMS oscillator portion for explaining operation in a pressurized state.

FIG. 3 shows the MEMS pressure sensor according to the first embodiment. FIG. 3(a) is a plan view in which the diaphragm portion has a circular planar shape. FIG. 3(b) is a plan view in which the diaphragm portion has a hexagonal planar shape. FIG. 3(c) is a cross-sectional view showing the pressurized state.

FIGS. 4(a) and 4(b) are plan views for explaining the arrangement of a first fixed electrode in the MEMS pressure sensor according to the first embodiment.

FIG. 5 shows another form of the MEMS pressure sensor according to the first embodiment. FIG. 5(a) is a plan view. FIG. 5(b) is a cross-sectional view taken along C-C′ shown in FIG. 5(a). FIG. 5(c) is an enlarged cross-sectional view of a MEMS oscillator portion.

FIG. 6 is a cross-sectional view showing another form of the MEMS pressure sensor according to the first embodiment.

FIG. 7 shows an altimeter according to a second embodiment. FIG. 7(a) is a view of the configuration. FIG. 7(b) is an enlarged view of a D portion shown in FIG. 7(a).

FIG. 8 is a partial cross-sectional view showing an altimeter according to another embodiment.

FIG. 9 is a view of appearance showing a moving object according to a third embodiment.

### DETAILED DESCRIPTION

Hereinafter, embodiments of the invention will be described with reference to the drawings.

### First Embodiment

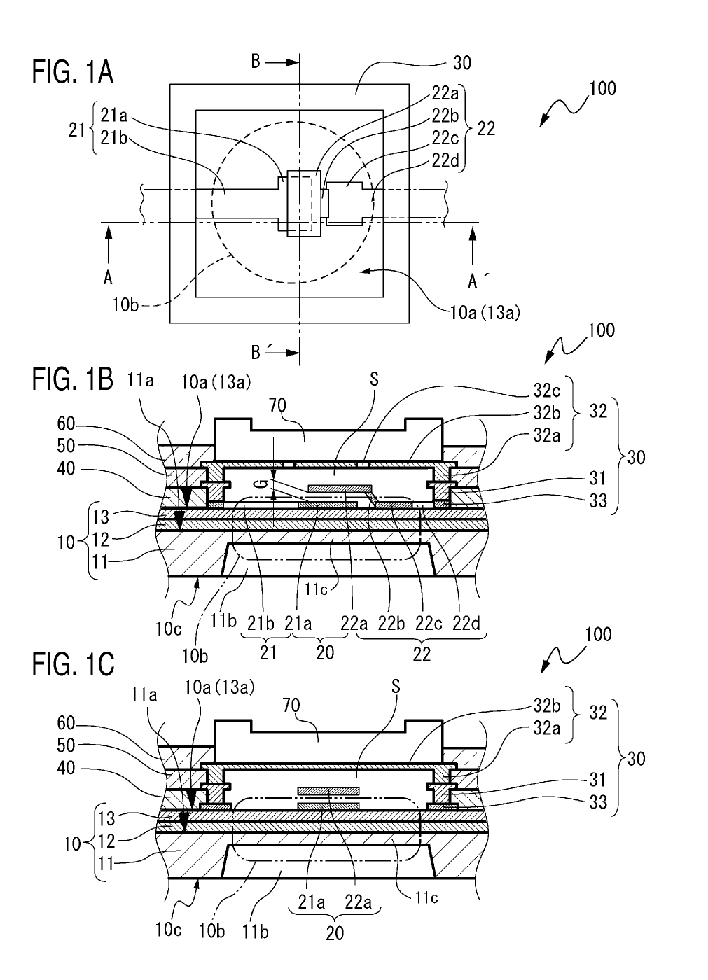

FIG. 1 shows a MEMS pressure sensor according to a first embodiment. FIG. 1(a) is a plan view, seen by penetrating a covering layer, described later. FIG. 1(b) is a cross-sectional view taken along A-A′ shown in FIG. 1(a). FIG. 1(c) is a cross-sectional view taken along B-B′ shown in FIG. 1(a). As shown in FIG. 1(b), a MEMS pressure sensor 100 according to this embodiment includes a substrate 10 made up of a wafer substrate 11, a first oxide film 12 formed on a main surface 11a of the wafer substrate 11, and a nitride film 13 formed on the first oxide film 12. The wafer substrate 11 is a silicon substrate and is also used as a wafer substrate 11 forming a semiconductor device or so-called IC, described later.

A MEMS oscillator 20 as a resonator is formed on a main surface 10a as a first surface of the substrate 10, that is, on a surface 13a of the nitride film 13. The MEMS oscillator 20 includes a first fixed electrode 21a provided in a first conductor layer 21 shown in FIG. 1(b), and a movable electrode 22a provided in a second conductive layer 22 as a drive electrode. As shown in FIG. 1(b), the first conductive layer 21 has a first wiring portion 21b connected to the first fixed electrode 21a and an external wire, not shown. Also, the second conductive layer 22 has the movable electrode 22a, a second fixed electrode 22c formed on the main surface 10a, and a supporting electrode 22b supporting the movable electrode 22a and connected to the second fixed electrode 22c, and has a second wiring portion 22d that connects the second fixed electrode 22c to an external wire, not shown. The first conductive layer 21 and the second conductive layer 22 are formed by photolithographic patterning of conductive polysilicon. It should be noted that, while an example where polysilicon is used for the first conductive layer 21 and the second conductive layer 22 is given in this embodiment, the first conductive layer 21 and the second conductive layer 22 are not limited to this example.

In the MEMS oscillator 20, a gap portion G as a space where the movable electrode 22a can move is formed between the first fixed electrode 21a and the movable electrode 22a. Also, the MEMS oscillator 20 is formed to be accommodated in a space S formed on the main surface 10a of the substrate 10. The space S is formed as follows. After the first conductive layer 21 and the second conductive layer 22 are formed, a second oxide film 40 is formed. In the second oxide film 40, to allow connection to a bottom layer 30 made of polysilicon of a space wall portion 30, described later, a hole where the bottom layer 33 is exposed is formed simultaneously with the formation of the second conductive layer 22, and a first wiring layer 31 is formed by photolithographic patterning.

Moreover, a third oxide film 50 is formed on the second oxide film 40. In the third oxide film 50, a hole where the first wiring layer 31 is exposed is formed, and a second wiring layer 32 is formed by photolithographic patterning. The second wiring layer 32 includes a wall portion 32a forming a top layer of the space wall portion 30, described later, and a lid portion 32b forming the space S housing the MEMS oscillator 20. Moreover, in the lid portion 32b of the second wiring layer 32, an opening 32c is provided for release etching of the second oxide film 40 and the third oxide film 50 in the area of the space S that are formed in the manufacturing process, in order to form the space S.

Next, a protection film 60 is formed to expose the opening 32c of the second wiring layer 32. An etching solution for etching the second oxide film 40 and the third oxide film 50 is introduced from the opening 32c, thus forming the space S by release etching. The space S is an area surrounded by the space wall portion 30 formed by the bottom layer 33, the first wiring layer 31 and the second wiring layer 32.

The gap portion G provided in the MEMS oscillator 20 is formed by the above release etching at the time of forming the space S. That is, after the first conductive layer 21 is formed, a fourth oxide film, not shown, is formed on the first fixed electrode 21a, and the movable electrode 22a is formed on the fourth oxide film. Then, the fourth oxide film is eliminated together with the second oxide film 40 and the third oxide film 50 by release etching, thus forming the gap portion G. The second oxide film 40, the third oxide film 50 and the fourth oxide film in the area corresponding to the space S, which are eliminated by the above release etching, are called sacrifice layers.

As the release etching ends and the space S is formed, a covering layer 70 is formed, covering the lid portion 32b of the second wiring layer 32 that is not covered by the protection film 60, and thus sealing the opening 32c. The space S is thus sealed airtightly.

The MEMS pressure sensor 100 is formed in this way. In the MEMS pressure sensor 100 according to this embodiment, a recessed portion 11b is formed on the wafer substrate 11 from aback side 10c of the substrate 10 as a second surface opposite to the main surface 10a of the substrate 10 corresponding to the MEMS oscillator 20. As the recessed portion 11b is formed, a thin portion 11c is formed in the area on the main surface 10a where the MEMS oscillator 20 is formed. This thin portion 11c, the first oxide film 12 formed on the thin portion 11c, and the nitride film 13, form a diaphragm portion 10b. In other words, the MEMS oscillator 20 is formed on the main surface 10a in the area of the diaphragm portion 10b.

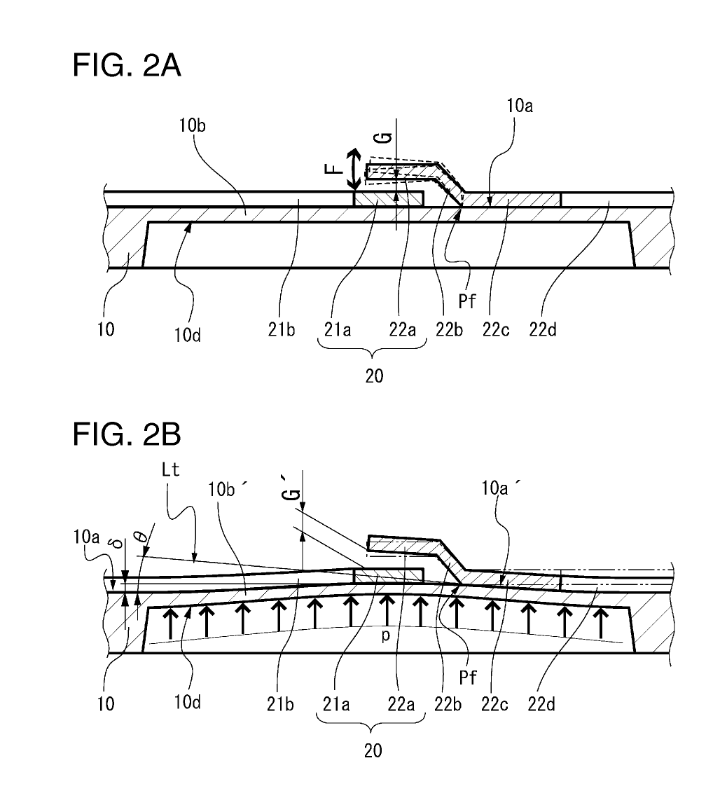

FIG. 2 is a view of the configuration for explaining the operation of the MEMS pressure sensor 100. The operation state of the MEMS pressure sensor 100 shown in FIG. 2(a) is the operation of the MEMS oscillator 20 in a so-called static state where an external pressure as an external force is not applied to the diaphragm portion 10b. As shown in FIG. 2(a), in the MEMS oscillator 20 in the static state, the movable electrode 22a is spaced apart by the gap portion G from the first fixed electrode 21a. The movable electrode 22a has a cantilever structure in which the movable electrode 22a is fixed to the substrate 10 by the second fixed electrode 22c, at a junction point Pf between the main surface 10a of the substrate 10 and the supporting electrode 22b as a fixing point. An electrostatic force generated by electric charges applied to the first fixed electrode 21a and the movable electrode 22a causes the movable electrode 22a to oscillate in an F-direction. Also, by detecting a change in the electrostatic capacitance of the gap portion G, oscillation characteristics such as oscillation frequency of the MEMS oscillator 20 can be acquired.

In the MEMS pressure sensor 100 having the MEMS oscillator 20 that can be made to oscillate as described above, a pressure p is applied as an external force to the diaphragm portion 10b of the substrate 10, as shown in FIG. 2(b), and the pressure p applied to a bottom surface 10d of the diaphragm portion 10b causes a stress to be applied to the diaphragm portion 10b. The main surface 10a of the substrate 10 is deformed into a main surface 10a′ having a flexure 8. At this time, the direction of a tangent Lt to the deformed main surface 10a′ of a diaphragm portion 10b′ deformed at the junction point Pf is inclined at an angle 8 to the main surface 10a of the substrate 10 where the diaphragm portion 10b is not formed.

With the angle of inclination 8 of the deformed main surface 10a′ relative to the main surface 10a, the movable electrode 22a is also inclined relative to the main surface 10a. As a result, a gap portion G′ following the deformation is enlarged from the gap portion G in the MEMS oscillator 20 in the static state. The electrostatic force between the first fixed electrode 21a and the movable electrode 22a changes, and the resonance frequency changes. By finding the relation between this change in the resonance frequency and the pressure p applied to the diaphragm portion 10b, the MEMS pressure sensor 100 can be provided.

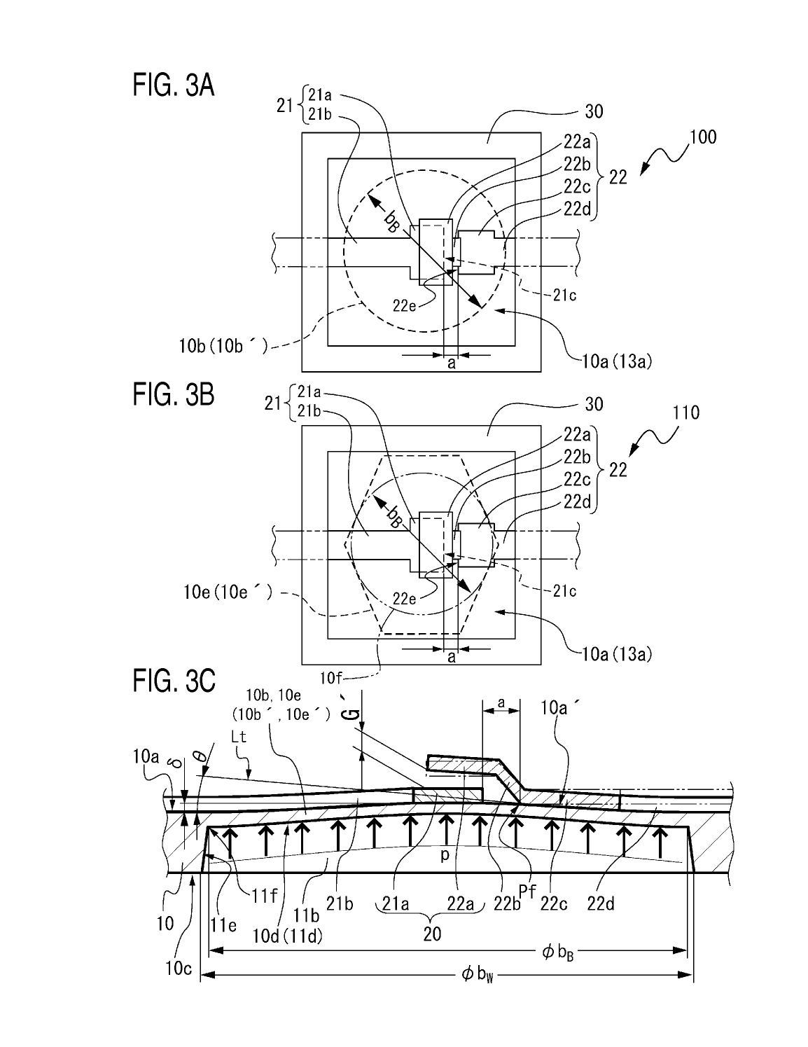

As described above, as the diaphragm portion 10b is deformed by the pressure p, the gap portion G changes into the gap portion G′ and this is detected as a change in the resonance frequency. Therefore, it is preferable that the first fixed electrode 21a and the movable electrode 22a are arranged in such a way as to increase the amount of change into the gap portion G′ following the change. The arrangement of the first fixed electrode 21a and the movable electrode 22a is described with reference to FIG. 3. FIG. 3(a) is a plan view of the MEMS pressure sensor 100, and FIG. 3(b) is a plan view of a MEMS pressure sensor 110. In the case of the MEMS pressure sensor 100 shown in FIG. 3(a), the diaphragm portion 10b has a circular shape as viewed in a plan view, and this is the same as the form shown in FIG. 1(a). In the case of the MEMS pressure sensor 110 shown in FIG. 3(b), a diaphragm portion 10e has a hexagonal shape as viewed in a plan view, as an example of a polygonal shape. FIG. 3(c) is a schematic cross-sectional view showing the MEMS oscillator 20 in the state where the pressure p is applied to the diaphragm portions 10b, 10e.

In the MEMS pressure sensor 100 shown in FIG. 3(a), the diaphragm portion 10b is formed in a circular shape as viewed in a plan view. As the positional relation between the first fixed electrode 21a and the movable electrode 22a, as shown in FIG. 3(a), there is a distance between a first fixed electrode end portion 21c of the first fixed electrode 21a facing the second fixed electrode 22c and a second fixed electrode end portion 22e of the second fixed electrode 22c facing the first fixed electrode 21a. That is, the first fixed electrode end portion 21c and the second fixed electrode end portion 22e are end portions facing each other, and the first fixed electrode end portion 21c and the second fixed electrode end portion 22e are spaced apart from each other by a distance a.

Also, the circular shape of the diaphragm portion 10b as viewed in a plan view is formed with a diameter φb_{B}. In this case, it is preferable that the distance a between the first fixed electrode end portion 21c and the second fixed electrode end portion 22e is set to meet the following condition.

0<a<0.3b_{B} (1)

As shown in FIG. 3(c), with the angle of inclination O relative to the main surface 10a of the substrate 10 where the diaphragm portion 10b is not formed, which is in the direction of the tangent Lt to the deformed main surface 10a′ of the diaphragm portion 10b′ deformed at the junction point Pf, the movable electrode 22a is spaced apart from the first fixed electrode 21a and the gap portion G′ is generated due to the application of the pressure p. Therefore, by setting the distance a under the condition expressed by the formula (1), the MEMS pressure sensor 100 having the MEMS oscillator 20 which can efficiently convert the deformation of the diaphragm portion 10b due to the applied pressure p into the change into the gap portion G′ and can securely detect the change in the resonance frequency due to the change of the gap portion G into the gap portion G′, while continuing oscillation drive of the movable electrode 22a, can be provided.

Meanwhile, in the case where the diaphragm portion 10e has a hexagonal shape as viewed in a plan view, as in the MEMS pressure sensor 110 shown in FIG. 3(b), the diameter of the inscribed circle 10f of an imaginary shape inscribed in the hexagonal planar shape may be regarded as the diameter b_{B}, and the distance a between the first fixed electrode end portion 21c and the second fixed electrode end portion 22e may be set to meet the condition of the formula (1).

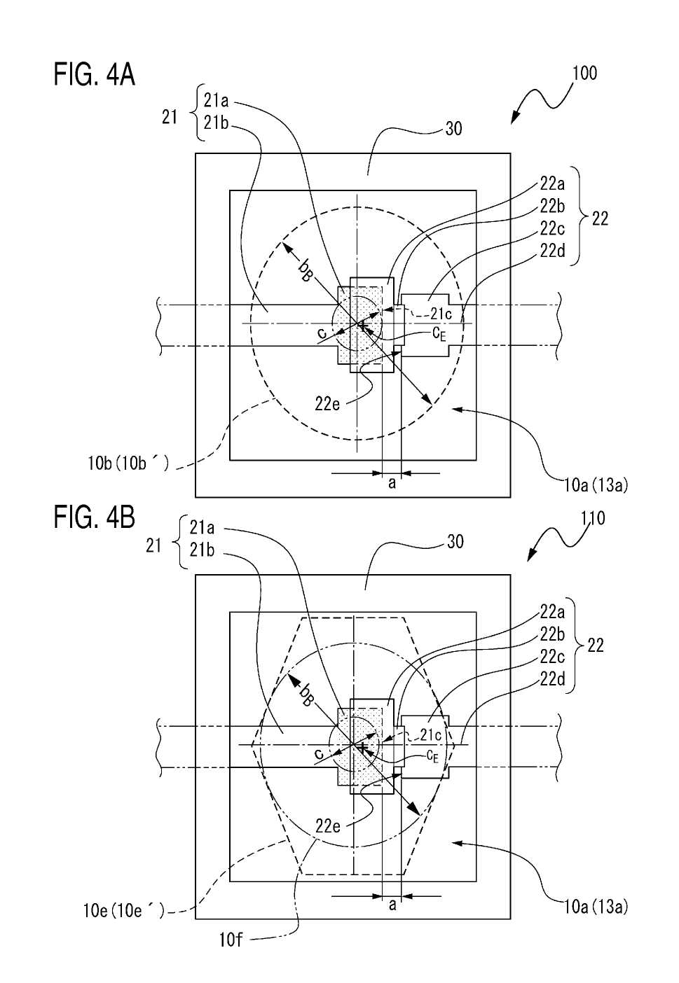

FIG. 4 is a plan view showing another arrangement of the MEMS oscillator 20 shown in FIGS. 3(a) and 3(b). FIG. 4(a) shows the case where the diaphragm portion 10b provided in the MEMS pressure sensor 100 has a circular shape as viewed in a plan view. FIG. 4 (b) shows the case where the diaphragm portion 10e provided in the MEMS pressure sensor 110 has a hexagonal shape as viewed in a plan view, as an example of a polygonal shape.

As shown in FIG. 4(a), the center C_{B} of the shape as viewed in a plan view (shaded portion as illustrated) of the first fixed electrode 21a is arranged to fall within a circular area having a diameter c that is concentric with the circle having the diameter b_{B} as viewed in a plan view of the diaphragm portion 10b. It is preferable that the diameter c of the circular area where the center C_{E} is arranged has the following relation.

0<c<0.93b_{B} (2)

As the first fixed electrode 21a is arranged in such a way that the planar shape center C_{E} of the first fixed electrode 21a is arranged within the area set by the condition expressed by the formula (2), and the distance a between the first fixed electrode end portion 21c and the second fixed electrode end portion 22e is set according to the condition expressed by the formula (1), the gap portion G′ can be made large even if the pressure p applied to the diaphragm portion 10b is small and therefore the flexure 8 is small.

As shown in FIG. 3(c), in the recessed portion 11b forming the diaphragm portion 10b, the diameter b_{W} of the opening of the recessed portion 11b on the back side 10c of the substrate 10 has the relation of

b_{B}<b_{W}

relative to the diameter b_{B} of the shape as viewed in a plan view on the bottom surface 10d. With this configuration, a corner portion 11f formed by a recessed portion bottom surface 11d of the wafer substrate 11 that corresponds to the bottom surface 10d and a recessed portion wall surface 11e, of the recessed portion 11b, does not have an acute angle, and damage to the wafer substrate 11 due to stress concentration or the like at the corner portion 11f can be restrained even if flexure and deformation of the diaphragm portion 10b is repeated. Moreover, etching performance for shaping the recessed portion 11b can be improved.

In the case of the MEMS pressure sensor 110 shown in FIGS. 4 (b), the center C_{E} of the shape as viewed in a plan view (shaded portion as illustrated) of the first fixed electrode 21a is arranged to fall within a circular area having a diameter c that is concentric with the inscribed circle 10f of an imaginary shape as viewed in a plan view of the diaphragm portion 10e. It is preferable that the diameter c of the circular area where the center C_{E} is arranged has the condition expressed by the formula (2).

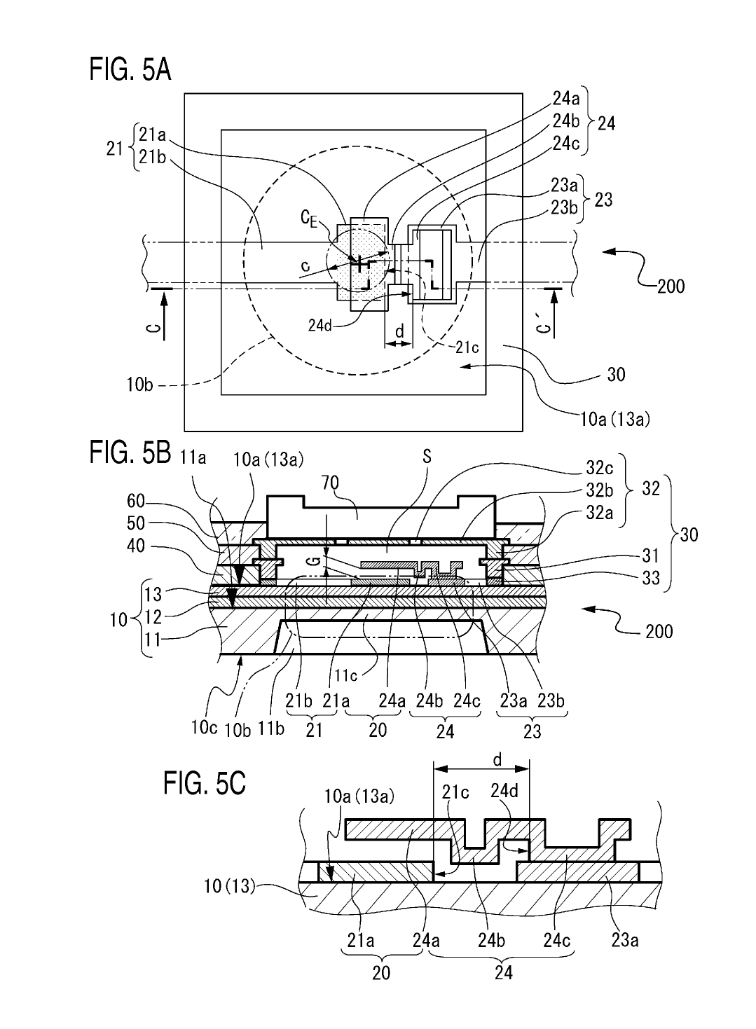

FIG. 5 shows another form of the MEMS pressure sensor. FIG. 5 shows a MEMS pressure sensor 200. FIG. 5(a) is a plan view, seen by penetrating the covering layer 70. FIG. 5(b) is a cross-sectional view taken along C-C′ shown in FIG. 5(a). The MEMS pressure sensor 200 is different from the above MEMS pressure sensors 100, 110 only in the configuration of the second conductive layer 22, and the same in the other configurations. Therefore, the same configurations as the MEMS pressure sensors 100, 110 are denoted by the same reference numerals and explanation thereof is omitted.

As shown in FIG. 5(b), in the MEMS pressure sensor 200, a MEMS oscillator 20 as a resonator is formed on a main surface 10a as a first surface of a substrate 10, that is, on a surface 13a of a nitride film 13. The MEMS oscillator 20 includes a first fixed electrode 21a provided in a first conductive layer 21, and a movable electrode 24a provided in a third conductive layer 24. In the third conductive layer 24, a supporting electrode 24b is provided extending from the movable electrode 24a. Then, a connection electrode 24c as a second fixed electrode is provided extending from the supporting electrode 24b. Also, a second conductive layer 23 is provided on the main surface 10a of the substrate 10. The second conductive layer 23 has a substrate electrode 23a. As the connection electrode 24c provided in the third conductive layer 24 is connected to the substrate electrode 23a, the third conductive layer 24 is fixed to the substrate 10 via the substrate electrode 23a. Also, the first conductive layer 21 has a first wiring portion 21b connected to the first fixed electrode 21a and an external wire, not shown. Moreover, the second conductive layer 23 has a second wiring portion 23b connected to the substrate electrode 23a and an external wire, not shown.

In the first conductive layer 21 and the second conductive layer 23, the first fixed electrode 21a and the substrate electrode 23a are formed by photolithographic patterning of a conductive polysilicon on the main surface 10a of the substrate 10. A fourth oxide film, not shown, is formed on the first fixed electrode 21a and the substrate electrode 23a thus formed. In the fourth oxide film on the substrate electrode 23a, an opening for forming the connection electrode 24c of the third conductive layer 24 on the substrate electrode 23a is provided. Then, the third conductive layer 24 is formed on the fourth oxide film. Then, the fourth oxide film is eliminated together with the second oxide film 40 and the third oxide film 50 by release etching. The gap portion G is formed as the gap between the first fixed electrode 21a and the movable electrode 24a.

In the MEMS pressure sensor 200 shown in FIG. 5, the diaphragm portion 10b is formed with a circular shape as viewed in a plan view. As the positional relation between the first fixed electrode 21a and the movable electrode 24a, as shown in FIG. 5(c), which is an enlarged view of the part of the MEMS oscillator 20, there is a distance between a first fixed electrode end portion 21c facing the substrate electrode 23a, of the first fixed electrode 21a, and a connection electrode end portion 24d facing the first fixed electrode 21a, of the connection electrode 24c of the third conductive layer 24. That is, the first fixed electrode end portion 21c and the connection electrode end portion 24d are end portions facing each other, and the first fixed electrode end portion 21c and the connection electrode end portion 24d are spaced apart from each other by a distance d.

If the circular shape of the diaphragm portion 10b as viewed in a plan view is formed with a diameter φb_{B}, it is preferable that the distance d between the first fixed electrode end portion 21c and the connection electrode end portion 24d is set to meet the following condition.

0<d<0.3b_{B} (3)

That is, the distance d is equivalent to the distance a in the formula (1) in the cases of the above MEMS pressure sensors 100, 110. Also, even in the case where a diaphragm that is the same as the diaphragm portion 10e having a hexagonal planar shape in the MEMS pressure sensor 110 is formed, the diameter of the inscribed circle 10f of an imaginary shape inscribed in the hexagonal planar shape may be regarded as the diameter b_{B} (see FIG. 3), and the distance d between the first fixed electrode end portion 21c and the connection electrode end portion 24d may be set to meet the condition of the formula (3).

Also, as shown in FIG. 5(a), the center C_{E} of the shape as viewed in a plan view (shaded portion as illustrated) of the first fixed electrode 21a is arranged to fall within a circular area having a diameter c that is concentric with the circle having the diameter b_{B} as viewed in a plan view of the diaphragm portion 10e. It is preferable that the diameter c of the circular area where the center C_{E} is arranged is set under the condition of the formula (2) also in the case of the MEMS pressure sensor 200.

According to the above MEMS pressure sensors 100, 110, 200, since the MEMS oscillator 20 is formed on the part of the main surface 10a of the diaphragm portion 10b that is flexed and deformed by an external pressure, even a slight flexure and deformation of the diaphragm 10b, that is, even a very small external pressure causes a change in the resonance frequency of the MEMS oscillator 20. Therefore, a pressure sensor capable of detecting such a change can be provided. Moreover, a small-sized pressure sensor that can be formed in the same process as a semiconductor process can be provided.

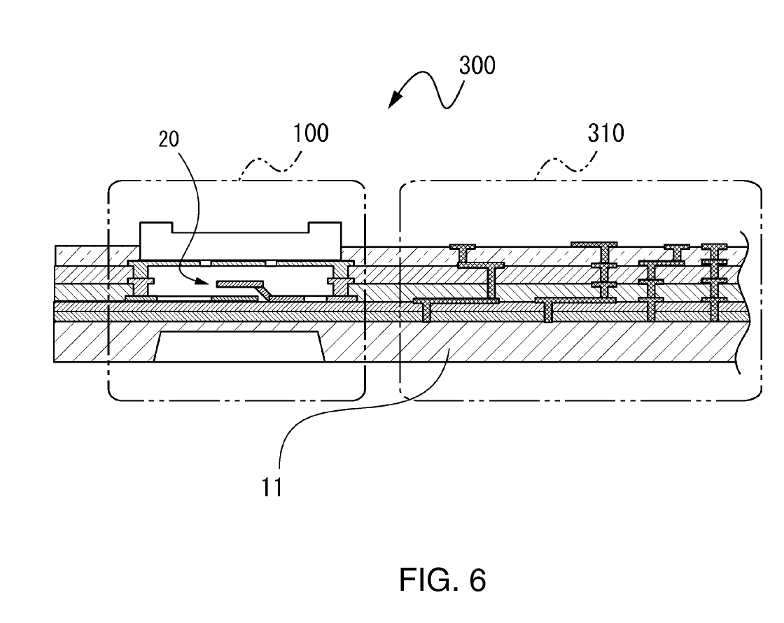

As described above, the MEMS pressure sensors 100, 110, 200 according to this embodiment are manufactured using a semiconductor process. Therefore, these MEMS pressure sensors can be integrated with a semiconductor device or so-called IC. FIG. 6 shows a configuration in which the above MEMS pressure sensor 100 and a semiconductor device are formed in one chip. A MEMS pressure sensor 300 shown in FIG. 6 has a configuration in which the MEMS pressure sensor 100 and a semiconductor device 310 are formed in one chip. The MEMS pressure sensor 100 is a micro device that can be manufactured by using a semiconductor manufacturing device and by a semiconductor manufacturing method. Therefore, the semiconductor device 310 can be easily formed on the same wafer substrate 11 as the MEMS pressure sensor 100. The semiconductor device 310 is provided with an oscillation circuit which drives the MEMS pressure sensor 100, and an arithmetic circuit which calculates a frequency change in the MEMS pressure sensor 100, and the like. As shown in the MEMS pressure sensor 300, by forming the semiconductor device 310 with the MEMS pressure sensor 100 in one chip, a MEMS pressure sensor as a small-sized sensor device can be provided.

### Second Embodiment

As a second embodiment, an altimeter will be described with reference to the drawings. The altimeter according to the second embodiment is a form of an electronic apparatus having a pressure sensor as an electronic device having the MEMS pressure sensor 100, 110, 200, 300 according to the first embodiment.

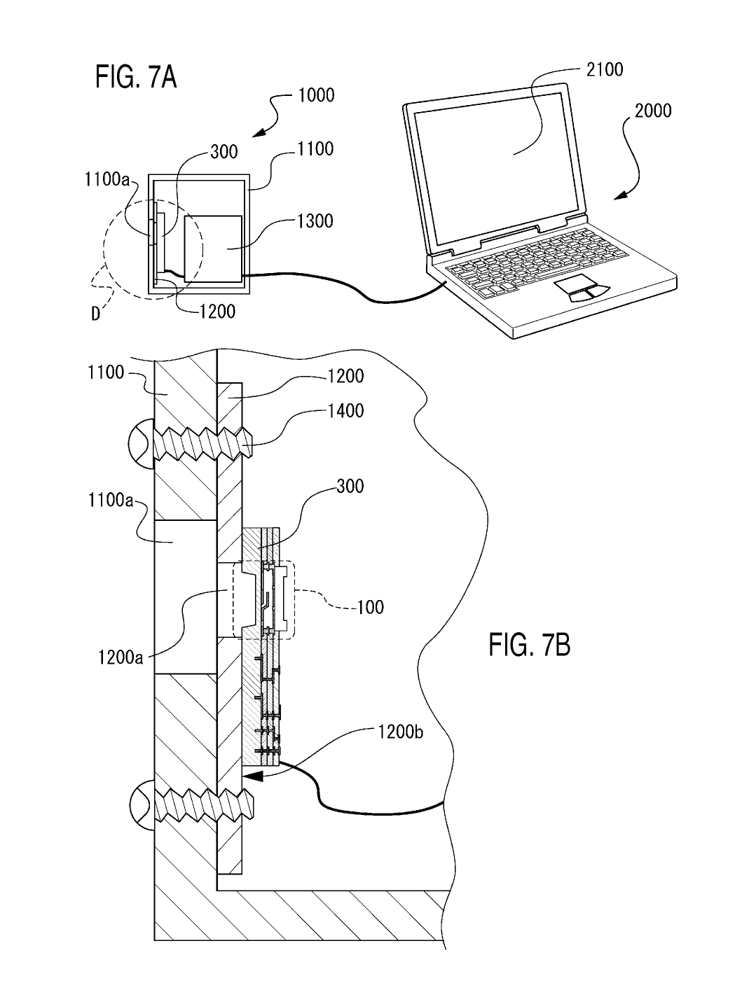

As shown in FIG. 7(a), an altimeter 1000 according to the second embodiment has, in a casing 1100, the MEMS pressure sensor 300 according to the first embodiment, a sensor fixture frame 1200 as a holding unit which holds the MEMS pressure sensor 300 and is installed in the casing 1100, and an arithmetic unit 1300 as a data processing unit which calculates a data signal obtained from the MEMS pressure sensor 300 into altitude data. In the casing 1100, an opening 1100a is provided through which air can circulate between the diaphragm portion 10b (see FIG. 1) of the MEMS pressure sensor 100 provided in the MEMS pressure sensor 300 and the atmosphere.

Details of a D portion shown in FIG. 7(a), that is, a cross-section of an installing portion of the MEMS pressure sensor 300, is shown in FIG. 7(b). As shown in FIG. 7(b), the diaphragm portion 10 of the MEMS pressure sensor 100 is arranged to be exposed to the side of the opening 1100a. Also, the sensor fixture frame 1200 has a through-hole 1200a, and the through-hole 1200a, too, is arranged in such a way that the diaphragm portion 10b of the MEMS pressure sensor 100 is exposed thereto. The sensor fixture frame 1200 and the MEMS pressure sensor 300 are bonded together by such measures as adhering to a bonding surface 1200b of the sensor fixture frame 1200. The sensor fixture frame 1200 with the MEMS pressure sensor 300 bonded thereto is installed in the casing 1100 with a screw 1400. The method for fixing the sensor fixture frame 1200 to the casing is not limited to the screw 1400 and may be such fixture measures as adhering.

In the altimeter 1000, air is circulated to and from the atmosphere in a pressure changing area applied to the diaphragm portion 10b of the MEMS pressure sensor 100 which air is allowed to circulate to and from via the opening 1100a in the casing 1100 and the through-hole 1200a in the sensor fixture frame 1200, and the altimeter 1000 detects the pressure in the atmosphere (hereinafter referred to as atmospheric pressure) and outputs altitude data. The outputted altitude data is transmitted to a personal computer 2000 (hereinafter referred to as PC 2000) having a display unit 2100 shown in FIG. 7(a) and is displayed on the display unit 2100 of the PC 2000. In this case, with processing software provided in the PC 2000, various kinds of data processing such as storing the altitude data, graph representation, and display on map data can be carried out. Also, a data processing device, a display unit, an external operation unit and the like can be provided in the altimeter 1000, instead of the PC 2000.

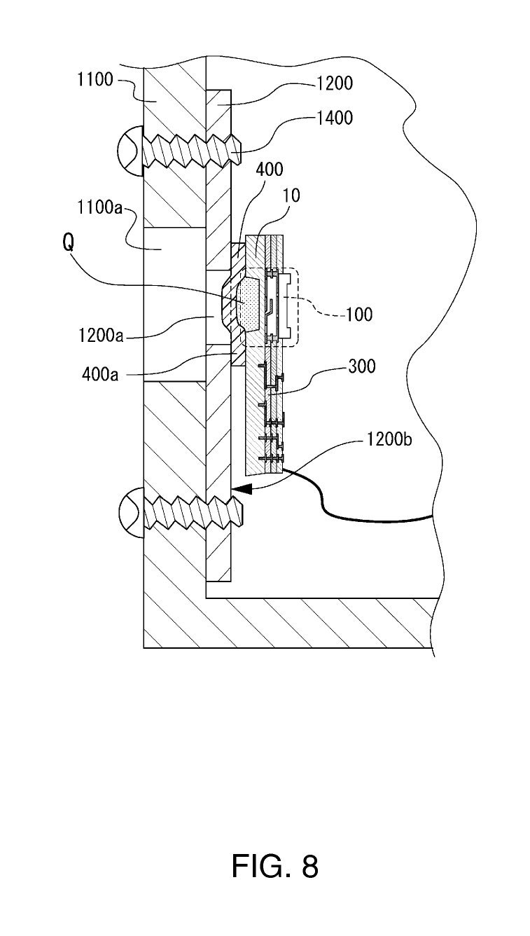

FIG. 8 shows another form of the MEMS pressure sensor 300 provided in the altimeter 1000 according to the second embodiment. FIG. 8 shows the D portion in FIG. 7(a), of the altimeter 1000 shown in FIG. 7(a). As shown in FIG. 8, a flexible film 400 having flexibility and airtightness is fixed to the MEMS pressure sensor 300. As the flexible film 400, for example, a material having elasticity and low gas permeability such as fluorine resin or synthetic rubber, or a metal thin film is preferable.

The flexible film 400 is arranged to cover the diaphragm portion 10b of the MEMS pressure sensor 100 and fixed to the substrate 10 at a flange portion 400a. In this case, a space Q (dot-hatched portion as illustrated) formed by the substrate 10 and the flexible film 400 is filled with gases, for example, air and inert gas, and formed as a pressure changing area. The MEMS pressure sensor 300 having the flexible film 400 is fixed to the sensor fixture frame 1200 and installed in the casing 1100.

Since the MEMS pressure sensor 300 has the flexible film 400, foreign bodies, dust and the like from outside can be prevented from attaching to the MEMS pressure sensor 100 and the MEMS pressure sensor 100 can be kept clean. Therefore, stable altimeter performance can be provided. Also, even if the external environment of the flexible film 400 has a liquid, corrosive gas or the like, damage to the MEMS pressure sensor 300 can be restrained.

### Third Embodiment

A navigation system as an electronic apparatus having the MEMS pressure sensor 100, 110, 200, 300 according to the first embodiment or the altimeter 1000 according to the second embodiment, and an automobile as an example of a moving object equipped with the navigation system, will be described.

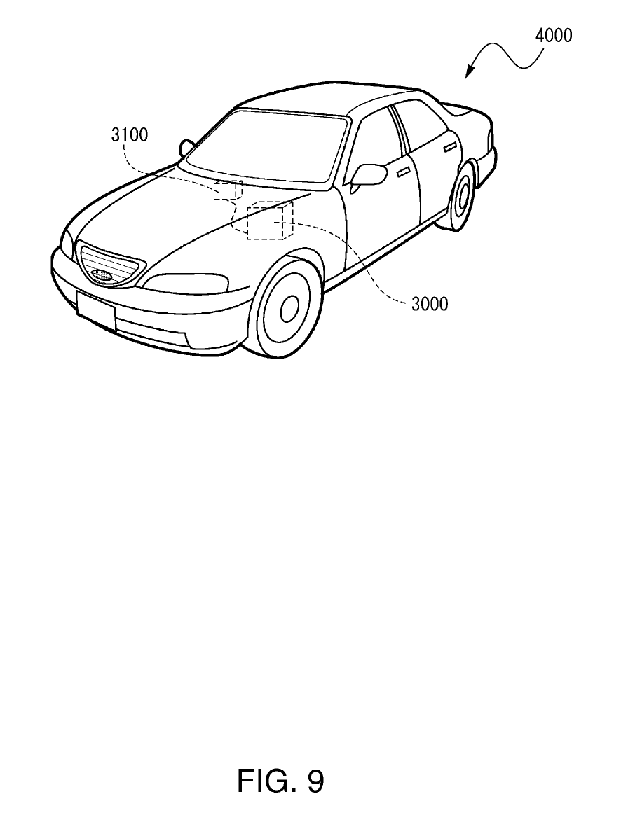

FIG. 9 is a view of the appearance of an automobile 4000 as a moving object having a navigation system 3000 as an electronic apparatus. The navigation system 3000 includes map information, not shown, a position information acquisition unit based on the GPS (global positioning system), an autonomous navigation unit using a gyro sensor, an acceleration sensor and vehicle speed data, and the altimeter 1000 according to the second embodiment, and displays predetermined position information or traveling route information on a display unit 3100 arranged at a position that can be visually recognized by the driver.

In the automobile 4000 shown in FIG. 9, since the altimeter 1000 is provided in the navigation system 3000, altitude information can be acquired in addition to the acquired position information. For example, in the case of traveling on an elevated road which represents substantially the same position as an ordinary road in terms of position information, if having no altitude information, the navigation system cannot determine whether the automobile is traveling on an ordinary road or an elevated road and consequently provides information about an ordinary road to the driver as priority information. Thus, in the navigation system 3000 according to this embodiment, altitude information can be acquired by the altimeter 1000, and a change in altitude due to entry into an elevated road from an ordinary road can be detected. Thus, navigation information of the traveling state on the elevated road can be provided to the driver.

Also, with the MEMS pressure sensor 100, 110, 200, 300 according to the first embodiment, a small-sized pressure detection device can be formed, and a hydraulic or air-pressure drive system can be easily incorporated in the automobile 4000. Thus, monitoring and control data of the pressure in the device can be easily acquired.

The entire disclosure of Japanese Patent Application No. 2013-089119, filed Apr. 22, 2013 is expressly incorporated by reference herein.

1. A MEMS pressure sensor comprising
a diaphragm portion that becomes displaced according to a pressure, and
a resonator arranged on a main surface of the diaphragm portion,
wherein the resonator includes
a first fixed electrode provided on the main surface, and
a drive electrode having a second fixed electrode provided on the main surface, a movable electrode spaced apart from the first fixed electrode, overlapping with the first fixed electrode, as viewed in a plan view seen from a normal direction to the main surface, and driven in a direction that intersects the main surface, and a supporting electrode supporting the movable electrode and connected to the second fixed electrode.

2. The MEMS pressure sensor according to claim 1, wherein the diaphragm portion has a recessed portion arranged on a back side of the main surface, and a thin portion made up of a bottom surface of the recessed portion and the main surface, and
if a distance between opposite ends of the first fixed electrode and the second fixed electrode is a, and
a diameter of an inscribed circle in a planar shape as viewed in a plan view seen from a normal direction to the main surface, of the recessed portion of the diaphragm portion, is b_{B},
0<a≦0.3b_{B}
holds.

3. The MEMS pressure sensor according to claim 2, wherein the first fixed electrode is arranged in an area that is concentric with the inscribed circle, having a diameter c in a planar shape as viewed in a plan view seen from a normal direction to the main surface, of the recessed portion of the diaphragm portion, and
the diameter c is
0<c≦0.93b_{B}.

4. The MEMS pressure sensor according to claim 2, wherein if a diameter of a bottom-surface inscribed circle in a planar shape in the bottom surface of the recessed portion is b_{B}, and
a diameter of an opening inscribed circle in a planar shape in an opening of the recessed portion on the back side is b_{W},
as viewed in a plan view seen from a normal direction to the main surface,
b_{B}<b_{W}
holds.

5. The MEMS pressure sensor according to claim 3, wherein if a diameter of a bottom-surface inscribed circle in a planar shape in the bottom surface of the recessed portion is b_{B}, and
a diameter of an opening inscribed circle in a planar shape in an opening of the recessed portion on the back side is b_{W},
as viewed in a plan view seen from a normal direction to the main surface,
b_{B}<b_{W}
holds.

6. An electronic device comprising:
the MEMS pressure sensor according to claim 1; and
a holding unit that holds the opening and the bottom surface of the recessed portion on the back side of the substrate, in a state of being exposed to a pressure changing area.

7. An altimeter comprising:
the MEMS pressure sensor according to claim 1;
a holding unit that holds the opening and the bottom surface of the recessed portion on the back side, in a state of being exposed to a pressure changing area; and
a data processing unit that processes measurement data from the MEMS pressure sensor.

8. An electronic apparatus comprising the MEMS pressure sensor according to claim 1, an electronic device or an altimeter.

9. A moving object comprising the MEMS pressure sensor according to claim 1, a pressure sensor device, an altimeter or an electronic apparatus.
